(19) United States
(12) Patent Application Publication
(10) Pub. No.: US 2010/0030619 A1
(43) Pub. Date: Feb. 4, 2010

(54) SYSTEM AND METHOD FOR COMPUTERIZED ANALYSES OF SHOPPING BASKET PARAMETERS

(75) Inventors: Amir OFER, Jerusalem (IL); Ofer BER, Herzelia (IL)

Correspondence Address: OLIFF & BERRIDGE, PLC, P.O. BOX 320850, ALEXANDRIA, VA, 22320-4850, US

(73) Assignee: DOLPHIN SOFTWARE LTD., Lod (IL)

(21) Appl. No.: 12/402,137

(22) Filed: Mar. 11, 2009

Related U.S. Application Data
(63) Continuation-in-part of application No. 11/349,130, filed on Feb. 8, 2006.
(60) Provisional application No. 60/655,410, filed on Feb. 24, 2005.
(60) Provisional application No. 60/719,963, filed on Sep. 26, 2005.

(51) Int. Cl. G06Q 30/00; G06Q 10/00

(52) U.S. Cl. 705/10; 705/27

(57) ABSTRACT

There are provided a system and a method for computerized analyses of shopping basket parameters. The method comprises obtaining a specification of an initial shopping basket; generating a list of associated products available in the shops of interest; generating shopping basket corresponding to the shops of interest; calculating and comparing the prices of the respective baskets. The method may further comprise obtaining a plurality of previous order lists and a current order list corresponding to respective shops; identifying for one or more products in the current order list at least one previous order list comprising a product associated in the list of associated products to the product in the current order list as “replacing”; and calculating a replacing score. The method may also comprise generating an aggregated shopping basket corresponding to said shops of interest; analyzing the obtained computerized order lists together with the generated aggregated shopping basket, thereby calculating weights of the products comprised in the aggregated shopping basket; and calculating a weighted price of the aggregated shopping basket.

### CROSS REFERENCE TO RELATED APPLICATIONS

The present application is a continuation-in-part of US application 2008/167969 which claims the benefit of prior U.S. provisional patent applications 60/655,410 filed Feb. 24, 2005 and 60/719,963 filed Sep. 26, 2005. The entire contents of these applications are hereby incorporated by reference in their entirety.

### FIELD OF INVENTION

The invention relates to the field of computerized shopping and, more specifically, to systems and methods for computerized analyses of shopping parameters, including price monitoring and price comparison.

### BACKGROUND OF THE INVENTION

With the proliferation of networked computer systems, there has been a corresponding evolution of computerized shopping, including computerized ordering, computerized price comparison, computerized price monitoring, computerized personalization of shopping marketplace and other shopping-related aspects. The problems of computerized analyses of shopping parameters have been recognized in prior art and various systems have been developed to provide a solution, for example:

U.S. Pat. No. 6,873,968 (Ehrlich et al.) discloses a price comparison and adjustment system which can be used in the context of an Internet environment. The system comprises a server based browser, a shopping cart manager, an extraction and verification module, a validation module, and a counter offer module. The system provides an Internet shopper with a method for comparison shopping online while allowing the shopper control over the comparison-shopping search, which also enables a host merchant to counter-offer prices at rival merchants' web sites. The system creates a portable virtual shopping cart that allows the Internet user to browse rival merchants without leaving the host merchant's web site, and further allows the shopper to quickly return to the host merchant's web site to purchase items in the virtual shopping cart.

U.S. Pat. No. 7,107,226 (Cassidi et al.) discloses a searchable database comprising a multiplicity of tables including an attributes table and a values table for a multiplicity of target search items constructed and arranged so that selection of values for one or more target search item attributes yields an attribute-value construct specifying a particular one of said target search items and precluding an indeterminate search result. Such a database may be employed in an online comparison shopping system comprising a database containing product information of multiple vendors, manufacturers and/or products and a user interface generating a virtual shopping cart, and constructed and arranged to enable a user to selectively aggregate an order in said virtual shopping cart, comprising products represented in said database, and means for electronically disaggregating said order to generate vendor-specific orders to respective vendors.

US Patent Application No. 2004/19536 (Ashkenazi et al.) discloses a system and method for facilitating online comparison shopping, including a similarity engine, a navigational system, and a step skipping system. The system and method according to the invention include a method for determining similarity between two preferably disparate products. The system and method also preferably include a method of increasing efficiency of navigation in a comparison shopping site based on product coverage and product entropy. The system and method further include a method of step-skipping to quicken user navigation through a comparison shopping site.

### SUMMARY OF THE INVENTION

There is a need in the art to provide a system and method of analyzing parameters of shopping baskets and oriented to special features of certain market segments (e.g. Supermarket, Food and Grocery (SFG), semiconductor components, building materials, drugstores, electronic components and spare parts, office supplies, etc.) characterized by multiple, typically replaceable, items from multiple vendors collected in one shopping basket. By way of non-limiting example, among specific features of such segments and corresponding shopping baskets are:
Associated products, wherein the association may include:
   similarity relationship of the products, including potential substitutions in case of missing items, and potential replacements by products with other value (e.g. less expensive, higher quality, etc.);
   product—product's part relationship (e.g. components, spare parts, etc.);
   product—bundled products relationship (e.g. products within promotional offering);
   product—accompanying products relationship, including accessories related to the product, complementary products (e.g. drop cloths, paint rollers and turpentine may be complementary products for a paint brush), etc.
Hidden identities, similarities and differences between products, e.g. replaceable products may have different names or may be offered under different brands; also non-replaceable products may have similar names;
Package-related alternatives (e.g. “Sugar, 2 Kg” may be supplied by 4×500 gr sugar bags, by 2×1 Kg sugar cans or by a 1×2 Kg sugar can), etc.;
Delivery-related alternatives (e.g. when replaceability of items depends on delivery time);
Dynamic user's preferences and optimization criterion (e.g. preferred and/or restricted products, ingredients, manufacturers, brands, suppliers, shops, packaging, delivery time, etc), etc.

According to certain aspects of the present invention, there is provided a method for computerized analyses of shopping basket parameters for at least a first shop of interest, the method comprising: obtaining a specification of an initial shopping basket; generating a list of associated products available in, at least, the first shop of interest; generating a first shopping basket corresponding to said first shop of interest and further calculating a price of the generated first shopping basket.

According to further aspects of the present invention, the method further comprises generating a second shopping basket corresponding to a second shop of interest; calculating a price of the generated second shopping basket, and comparing the prices of the first and the second shopping baskets, wherein the list of associated products is generated in accordance with products available, at least, in the first and in the second shops of interest. Optionally, specification of initial basket may correspond to the products of the second shop.

According to further aspects of the present invention, generating the list of associated products comprises adjusting the list in accordance with specified preferences and/or product availability at a certain period of time and/or market segment and/or delivery-related characteristics and/or package-related characteristics.

According to further aspects of the present invention, generating the shopping basket for the shop of interest includes matching the list of associated products to the products available in the shop in order to identify one or more products corresponding to a certain product specified in the initial basket, and selecting among the identified products one or more products to be included in the shopping basket generated for the shop.

According to further aspects of the present invention, the method additionally or alternatively comprises obtaining a plurality of order lists corresponding to, at least, said first shop of interest, and updating the specification of the initial shopping basket in accordance with analyses of, at least, said shopping lists and the generated first shopping basket.

According to further aspects of the present invention, the method additionally or alternatively comprises obtaining a plurality of previous order lists corresponding to, at least, said first shop of interest and arranged in accordance with dates of the orders, obtaining a current order list corresponding to, at least, said first shop of interest, identifying for one or more products in the current order list at least one said previous order list comprising a product associated in said list of associated products to the product in the current order list as “replacing”; and calculating a replacing score. The method may further comprise obtaining an initial replacing score of said one or more products, and updating the replacing score of said products in accordance with replacing score calculated in accordance with the obtained current order list. The calculated replacing score may be used for estimation of a loyalty to the product of one or more buyers.

According to further aspects of the present invention, the method additionally or alternatively comprises obtaining a plurality of previous order lists corresponding to, at least, said first shop of interest and arranged in accordance with dates of the orders, obtaining a current order list corresponding to, at least, said first shop of interest, identifying for one or more products in the current order list at least one said previous order list comprising a product associated in said list of associated products to the product in the current order list as “bundled”; and calculating a bundling score.

According to other aspects of the present invention, there is provided a method for computerized analyses of shopping basket parameters for a plurality of shops of interest, the method comprising: obtaining a specification of an initial shopping basket; generating a list of associated products available in said plurality of shops of interest; obtaining a plurality of computerized order lists corresponding to said plurality of shops of interest and to a certain period of time; generating an aggregated shopping basket corresponding to said plurality of shops of interest; analyzing the obtained plurality of the computerized order lists together with the generated aggregated shopping basket, thereby calculating weights of the products comprised in the aggregated shopping basket; and calculating a weighted price of the aggregated shopping basket. The specification of the initial shopping basket may be updated in accordance with the calculated weights of products. The calculated weighted price may be used for monitoring a consumer-related index.

According to other aspects of the present invention, there is provided a system for computerized analyses of shopping basket parameters for at least a first shop of interest, the system comprising: means for obtaining a specification of an initial shopping basket; means for generating a list of associated products available in, at least, the first shop of interest; and means for generating a first shopping basket corresponding to said first shop of interest.

According to other aspects of the present invention, there is provided a system for computerized analyses of shopping basket parameters for a plurality of shops of interest, the system comprising means for obtaining a specification of an initial shopping basket; means for generating a list of associated products available in said plurality of shops of interest; means for obtaining a plurality of computerized order lists corresponding to said plurality of shops of interest and to a certain period of time; means for generating an aggregated shopping basket corresponding to said plurality of shops of interest; means for analyzing the obtained plurality of the computerized order lists together with the generated aggregated shopping basket, thereby calculating weights of the products comprised in the aggregated shopping basket; and means for calculating a weighted price of the aggregated shopping basket.

Among advantages of certain embodiments of the present invention is the capability to analyze shopping baskets with multiple, typically replaceable items. Among further advantages of certain embodiments of the present invention is capability to provide the analyses of shopping basket parameters in real-time or near real-time modes, as well as dynamically amend the analyzing shopping basket in accordance with ordering history.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 illustrates a generalized diagram of a system for computerized analyses of shopping basket parameters in accordance with certain embodiments of the present invention;

FIG. 2 illustrates a generalized flow diagram showing the principal stages of operating the price comparing and/or price monitoring process for shopping baskets in accordance with certain embodiments of the present invention;

FIG. 3 illustrates a generalized flow diagram showing the principal stages of generating a list of associated products distances in accordance with certain embodiments of the present invention;

FIGS. 4a and 4b illustrate exemplified calculations of association distances in accordance with certain embodiments of the present invention;

FIG. 5 illustrates a generalized flow diagram showing the principal stages of operating an index monitoring process in accordance with certain embodiments of the present invention; and

FIG. 6 illustrates a generalized flow diagram showing the principal stages of operating the product ranking process in accordance with certain embodiments of the present invention.

### DETAILED DESCRIPTION OF EXEMPLARY EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, “generating” or the like, refer to the action and/or processes of a computer that manipulate and/or transform data into other data, said data represented as physical, such as electronic, quantities. The term “computer” should be expansively construed to cover any kind of electronic device with data processing capabilities, including, by way of non-limiting example, personal computers, servers, computing system, communication devices, processors (e.g. digital signal processor (DSP), microcontrollers, field programmable gate array (FPGA), application specific integrated circuit (ASIC), etc.) and other electronic computing devices.

The operations in accordance with the teachings herein may be performed by a computer specially constructed for the desired purposes or by a general purpose computer specially configured for the desired purpose by a computer program stored in a computer readable storage medium.

In addition, embodiments of the present invention are not described with reference to any particular programming language. It will be appreciated that a variety of programming languages may be used to implement the teachings of the inventions as described herein.

The term “criterion” used in this patent specification should be expansively construed to cover any compound criterion, including, for example, several criteria and/or their combination.

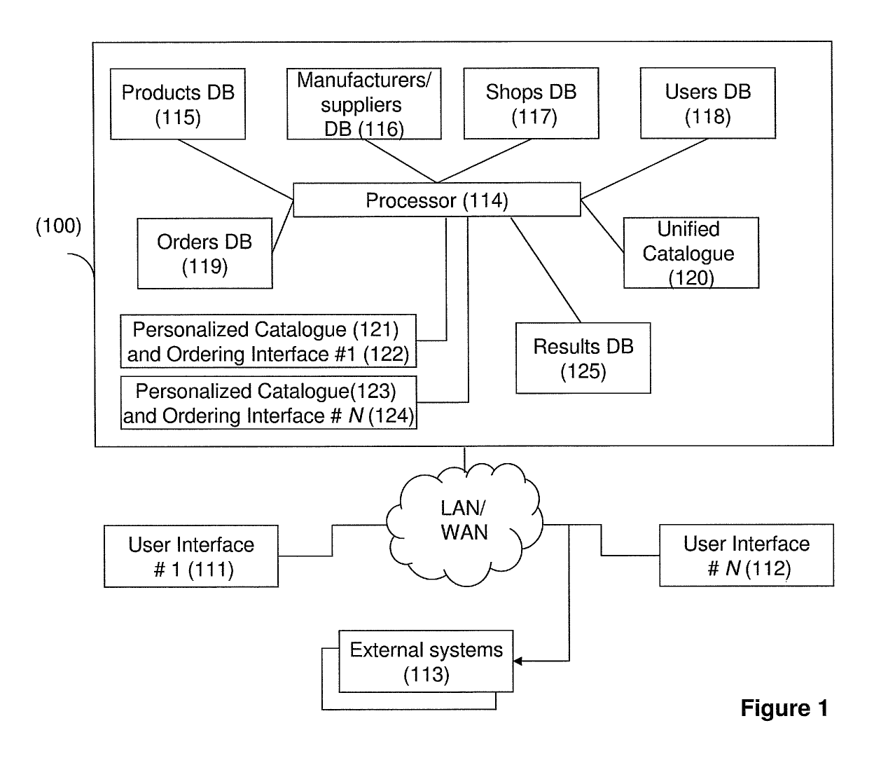

Referring to FIG. 1, there is schematically illustrated a system (100) for computerized analyses of a shopping basket's parameters in accordance with certain embodiments of the present invention.

The system (100) may be implemented on a single computer or its functionality may be distributed among several different computers running several applications and connected directly or via Wire-line, Wireless, cable, Voice over IP, Internet, Intranet, or other networks, using any communication standard, system and/or protocol and variants or evolution thereof. The system (100) may be operatively connected to other systems (113) (as, for example, one or more computerized shopping sites) and/or one or more user interfaces (111, 112). The user interface may be associated with any communication device having input and display capabilities (e.g. personal computer, workstation, PDA, telephone, WebTV device, etc.) and capable to communicate with the system (100) directly or via telecommunication network (e.g. Wireline or Wireless Public Telephone Networks, Internet, Intranet, cable network, etc.). In certain embodiments of the present invention the user interface may comprise a web-browser. In certain embodiments of the invention the user's interface may be directly associated with the system (100).

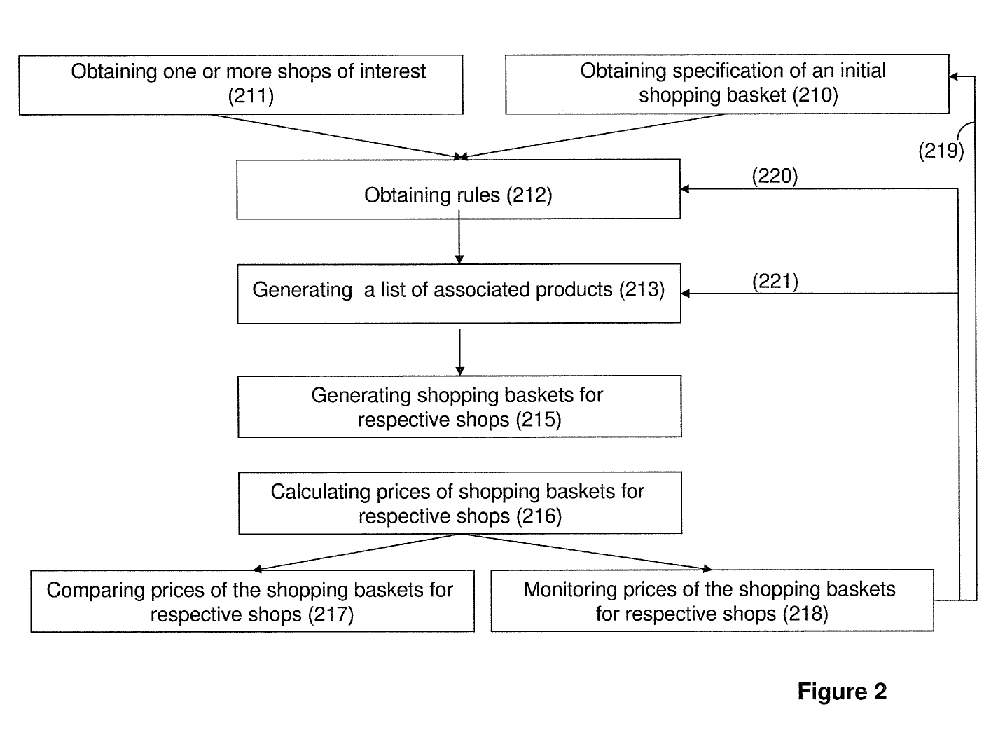

The system (100) contains a processor (114) operatively coupled to one or more data repositories. The processor is configured to execute calculations and data management necessary for the analyses process in accordance with the present invention (as will be further detailed with reference to FIGS. 2-6) and contains necessary algorithms and programs. In certain embodiments of the invention part of the calculations and/or data management may be executed by external systems. The data repositories comprise product-related, shop-related, buyer-related and order-related information.

By way of non-limiting example, the processor is operatively coupled to a products database (115), manufacturers/suppliers database (116), a shops database (117), a buyers database (118), an orders database (119), and a results database (125). The processor provides necessary processing and management of data stored in the databases as well as management of a unified catalogue (120).

The product database (115) contains product-related information. Products are typically characterized by attributes as, e.g. specific ingredients, weight, packing, manufacturer, supplier, shop, brand, price (term “price” is related hereinafter to any aspect of the prices provided by manufacturer, supplier and/or seller—including discounts, coupons, “buy one get two”, etc.), expiry period, etc. and values thereof.

The products database may also contain linking of products with one or more product groups as will be further explained with reference to the unified catalog (120).

The products database also contains, for each or some of the products, association-related information including information related to associated products and/or association-related values thereof. Associated products include, by way of non-limiting example:
similar products including replaceable products as, for example, potential substitutions (e.g. alternatives with same value), value-replacements (e.g. alternatives with other value, e.g. less expensive, higher quality, etc.) of the product, etc.;
parts of the product, e.g. components, spare parts of the product, etc.
bundled products, e.g. for promotional offers
accompanying products, e.g. complementary products, accessories related to the product, etc.

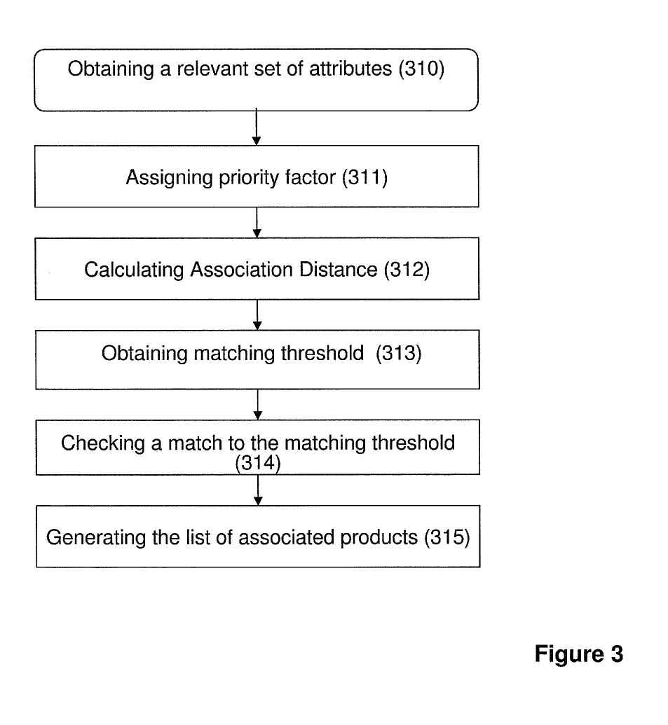

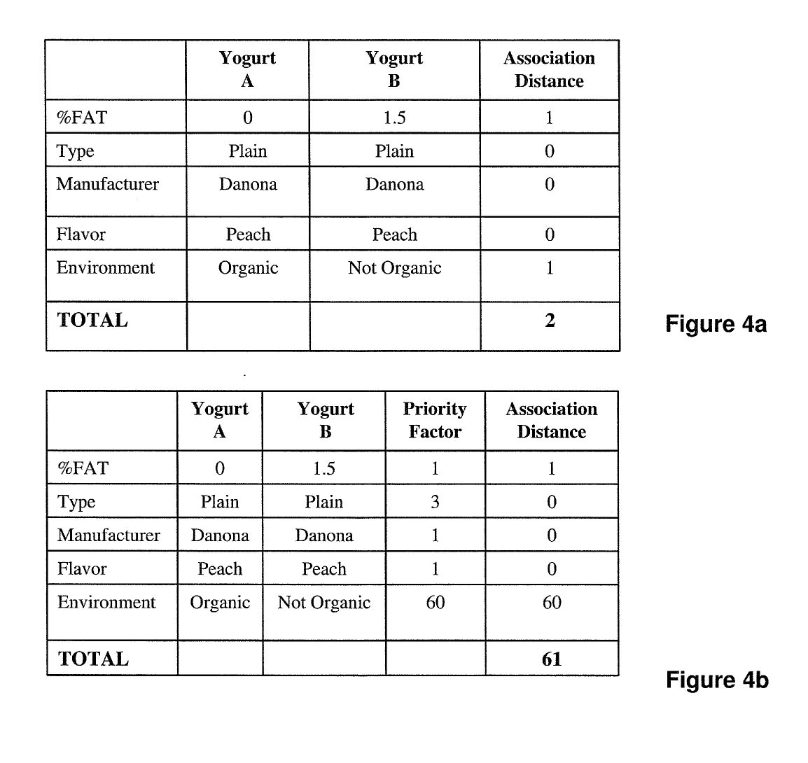

The association-related values will be further explained with reference to FIGS. 3-4.

The manufacturers'/suppliers' database (116) contains basic information on manufacturers and suppliers. The shops database (including manufacturers and suppliers directly supplying to end-users) (117) contains basic information on shops, as well as delivery related information (e.g. delivery schedules and prices for different geographical regions, etc.) and price information of the various products selling by respective shops.

Each of the above databases may also contain statistical information related to products, manufacturers, suppliers and/or shops (e.g. statistical ranking per usage, buyers' preferences, etc.). For example, the statistical information may include the ordered quantities for each product, distribution of ordered products and entire orders per shops, suppliers, manufacturers, how many buyers put the products/shops/suppliers/manufacturers on their black list (i.e. “never suggest this to me”) or white list (i.e. “this is always the preferred alternative”), geographic or demographic-related distribution of orders, etc. Alternatively or additionally, the statistical information may be accommodated in the results database (125).

The buyers' database (118) contains personal information about buyers (e.g. name, address, account and payment details, etc.). The database may also contain information about personal preferences (e.g. preferred and/or restricted ingredients, manufacturers, brands, suppliers, shops, packaging, delivery time, etc.) as well as historical and statistical information (e.g. previous orders, favorite items, amount of money spent in each shopping session, etc).

The results database (125) contains results of analyses provided by the processor in accordance with the teachings of the present invention.

In accordance with certain embodiments of the invention the computerized unified catalogue (120) comprises product-related information (or part of it) from the above databases. The products (and related information) in the catalogue may be arranged in groups. In certain embodiments of the invention a product group comprises one or more products associated with a generic product and/or a primary product. The groups may be organized in hierarchical, matrix, relative or other manner, while several groups may contain the same product. The products may be organized in one or more product groups in accordance with association criterion and/or generic/primary product. For example, all yogurt products may be organized in one group associated with generic product “yogurt” or may be organized in several groups in accordance with at least one of yogurt attributes (e.g. manufacturer, % fat, etc.) as an association criterion. The association of products may be provided per different criterion. The association criterion may be products similarity (products associated with at least one generic product or a primary product); association between a primary product and its components/bundled products/accompanying products, etc. For example, decaffeinated coffee A and B and caffeinated coffee C may be associated as similar products with a generic product “coffee”; a sugar M may be associated with coffee B as a complementary products; battery X, battery Y and charger Z may be associated with mobile phone V as accessories and between themselves as similar products being accessories for mobile phone V; battery X and battery Y may be associated as similar products with a generic product “battery” and/or “battery for a mobile telephone” and/or “battery for a mobile telephone V”; etc. In certain embodiments of the invention the association may be provided to (or between) a combination of products (e.g. shampoo+conditioner, products constituting a home cinema, etc.)

The similar products within a product group are sometimes, but not always, replaceable. For example, decaffeinated coffee A may be replaceable with decaffeinated coffee B, but is probably not replaceable with caffeinated coffee C although both A, B and C belong to the group of products associated with a generic product “Coffee”. Similar products with different prices may be, for example, not substitutable in case of missing items, but replaceable if providing higher quality, etc.

As well as the products database, the unified catalogue may contain, for each or some of the products, a list of associated products and/or association-related values referred hereto as association-related information.

In certain embodiments of the present invention the system (100) is configured to generate and present to a buyer (e.g. via user's interface) a personal catalogue (121, 123) based on data from the databases and/or the unified catalog, buyers' preferences (e.g. preferred and/or restricted products; ingredients, manufacturers, brands, suppliers, shops, packaging, delivery time, etc.) and, optionally, a history of the buyers' ordering. The personal catalogue may be generated for a period of the buyer's login to the system and/or may be stored and maintained in the system (100) and/or in a device associated with the user's interface.

Products and their grouping in the personal catalogue may be different from the unified catalog (e.g. depending on buyer's preferences, etc.). Typically, the personal catalogue does not contain information on products/manufacturers/shops/etc. included by the buyer in the personalized black list and/or products which are not delivered to the geographic region of the buyer. The personal catalogue does not necessarily contain all product-related data comprised in the unified catalogue. In some cases (e.g. if a buyer wishes to see all the products available), the personal catalogue may contain the same list of products as the unified catalogue, but, for example, with limited presentation of some product-related information and/or with different grouping.

Grouping of products (and/or combinations thereof) in association with a generic/primary product (and/or combination thereof) may be predefined, imported from a third party database, generated by a buyer and/or generated by the system in accordance with predefined rules (e.g. per buyer's preferences).

The personal catalogue may also comprise personalized association-related information. For example, the personalized replacement/substitution alternatives may be a subset of overall replacement/substitution alternatives contained in the unified catalogue, and in other cases may comprise replacement/substitution alternatives which are absent in the unified catalogue. For example, the unified catalog may contain three standard substitutions A, B and C for a specific product. One buyer may instruct the system to remove A from his personal list, while another buyer may specify the system to remove B and add D to his list. These changes may be done by each buyer either directly (i.e. explicitly mentioning a specific item) or/and by changing the association-related values of at least part of the products. As another example, in the unified catalogue, a product group of accessories for digital camera by manufacturer A may include products by different manufacturers. A buyer may instruct the system to limit the group to accessories provided by manufacturer A only. Such personalization may be provided via the user's interface.

The databases and the catalogues may be updated in different modes, for example, based on data received from different sources (e.g. suppliers, manufacturers, shops, agencies, Internet sites, etc.) in a push mode, per request of the system (100) (or database manager), etc. The input of data in the catalogue may be provided manually, combined (e.g. computerized input of basic product data and manual input of association-related values) or fully automated.

Optionally, the system (100) may be also capable to generate and present to each buyer (e.g. via user's interface) an ordering interface (122, 124) constructed and arranged to enable a buyer to compile a computerized order list based on selection of products. In preferred embodiments of the invention the ordering is provided based on the personalized catalogue; however the ordering process (or parts thereof) specified in the present invention may be implemented also based on the unified catalogue or/and one or more databases comprising product-related information.

In certain embodiments of the present invention the system is configured to receive the computerized order list compiled via the ordering interface (122, 124) or otherwise (e.g. compiled by a third party, compiled by the buyer via third party interface, etc.). The techniques of the present invention may be implemented for an order list fully or partially compiled externally in a manner similar to the order list fully compiled with the help of the system (100). The products included in said fully or partially externally compiled order list shall be comprised in the product database (115), and/or the system (100) may be configured to be capable of matching them to the products comprised in the database. The generated and/or obtained order lists are accommodated in the orders database (119).

In certain embodiments of the invention the system (100) is also capable to communicate with one or more third parties database(s) for obtaining respective data (for example, industry experts' assessment of replacement/substitution related values, DB of products' attributes and values thereof, DB of alternative products, etc.). The system (100) may be also capable to communicate with one or more external systems for providing the results of shopping basket analyses in a push and/or a pull mode. The results of analyses may be also presented via a display (not shown) comprised in the system (100) and/or via user's interface.

In certain embodiments of the invention the unified catalogue, the personal catalogue and/or ordering interface may be generated and/or presented by a device associated with the user's interface.

Those skilled in the art will readily appreciate that the invention is not bound by the configuration of FIG. 1; equivalent functionality may be consolidated or divided in another manner. In different embodiments of the invention, connection between the blocks and within the blocks may be implemented directly or remotely. The connection may be provided via Wire-line, Wireless, cable, Voice over IP, Internet, Intranet, or other networks, using any communication standard, system and/or protocol and variants or evolution thereof.

The described functions may be also provided while the blocks are being implemented (or integrated with) different equipment. Those skilled in the art will also readily appreciate that the data repositories may be consolidated or divided in another manner; some of these databases may be shared with other systems, including 3rd party equipment. Those skilled in the art will also readily appreciate that the unified and grouped organization of product-related information (unified catalogue) and its personalized presentation (personal catalogue) described in this patent specification may be implemented by different data management tools known in the art with no need to maintain the unified catalogue and/or the personal catalogue as dedicated databases.

FIG. 2 illustrates, by way of non-limiting example, a generalized flow diagram showing the principal stages of operating the computerized analyses of price characterizing one or more shopping baskets.

In accordance with certain embodiments of the invention, the analyses process starts with obtaining (210) a specification of a shopping basket of interest (referred to hereinafter as initial shopping basket) and obtaining (211) a list of one or more shops of interest. The term “shopping basket” used in this patent specification shall be expansively construed to include any group of one or more products, said group created for a purpose of analyses in accordance with the teachings of the present invention. The products in the basket are characterized, at least, by one or more attributes and values thereof (as was detailed with reference to Product DB in FIG. 1) and quantities. By way of non-limiting example, the shopping basket may be specified on a level of generic/primary products or, alternatively, at least part of the product may be specified with certain attributes and values thereof. The initial shopping basket may be specified independently of any shop (and/or any supplier and/or any manufacturer) or, alternatively, the products specified in the shopping basket may correspond to products in a certain shop or a group of shops having mutual characteristics as, e.g. attractive prices, supply chain, shopping place, quality of goods (e.g. organic, kosher, etc.). The list of products specified for the shopping basket may be fixed (pre-defined) or dynamic. For example, the products in the shopping basket may be dynamically specified as first X products mostly ordered during a certain period of time (e.g. among overall ordered products, and/or among products in certain segments, and/or among products with certain attributes' values, and/or among products ordered by certain segment of buyers, among products ordered in certain shops, or alike). The shopping basket may be also specified in accordance with certain indexes, derivatives or parts thereof.

The specification of the initial shopping basket may be obtained in different ways. By way of non-limiting example, the specification may be pre-defined in the system or may be received from an external system in a push or in a pull mode. Alternatively or additionally, the shopping basket may be generated by the system (100), based, for example, on statistical analyses and/or data mining of historical order-related data.

Those skilled in the art will readily appreciate that the invention is not bound by analyzing the shopping baskets for relevant shops of interest. In a similar manner the baskets may be analyzed for relevant suppliers and/or manufacturers and/or brands, etc.

Upon, before or in parallel to obtaining the specification of the initial shopping basket, the system obtains (212) one or more rules related to generation of shopping baskets corresponding to the specified shops and to calculation of the respective prices. In certain embodiments of the invention the rules may also include a set of relevant attributes corresponding to products specified in the shopping basket and the association criterion. The set of attributes and/or association criterion and/or the rules or part thereof may be obtained from one or more external systems, pre-defined in the system (100) and/or generated by the system (100) before or during the analyses process.

The system (100) further generates (213) a list of associated products corresponding to the products in the specification of the initial basket and available in the shops of interest. The term “available” used in this patent specification shall be expansively construed to include availability during a certain period of time and/or at a certain point in time (e.g. generally available products, available during last month, supposed to be available next month, currently available, etc.). In certain embodiments the list shall correspond to each product in the basket and each shop of interest; in other embodiments the list may be generated only for products and/or shops matching a certain criterion. Group of shops having mutual characteristics may be regarded as a single shop. By way of non-limiting example, said generation may be provided simultaneously when obtaining the shopping basket and/or the rules, with a predefined delay, periodically, per specific predefined event as, for example, buyer request, third party request, new obtained shop, updating the shopping basket with dynamic specification of products, etc.

In certain embodiments of the invention, the initial list of associated products corresponding to the basket specification may be obtained from external system(s), while the system (100) provides adjustment of the list in accordance with the shops of interest.

In certain embodiments of the invention all or part of the information necessary for generation of the list of associated products may be contained in the products database (or/and unified catalogue or/and personal catalogue). Alternatively or additionally, the list of associated products may be generated based on association calculations as illustrated by way of non-limiting example in FIG. 3.

As was mentioned with reference to FIG. 1, the product database (and/or unified catalogue and/or personal catalogue) comprises for each or some of the products one or more attributes characterizing the product and corresponding values thereof. In accordance with certain embodiments of the invention, generating the list of associated products starts with obtaining (310) (e.g. as a part of the rule set obtained at stage (212)) a set of attributes corresponding to products specified in the shopping basket and the association criterion (e.g. value-replacing products, substituting products, components, accompanying products, promotion offers, etc.). The association criterion depends on the purposes of further analyses. For example, the association criterion for price comparison or price monitoring of the shopping baskets is replaceability of products; for analyses of effectivity of product bundling the association criterion may correspond to replaceable and accompanying products and components, etc.

For example, the following attributes and values may be relevant for replacing type of association for the products associated with generically specified “Yogurt” in the shopping basket product (or, by way of alternative non-limiting example, to a detailed specified product e.g. Danona Organic plain 1% fat yogurt sold in Tesco):
% fat (0/1.5/3/5/9/15)
Type (Plain/with Fruit)
Manufacturer (Danona/Nestle/Benecol/etc.
Flavor (Strawberry/Vanilla/Peach/Chocolate/Apple/etc
Environment: Organic/Not Organic

In certain embodiments of invention the set of attributes may be specified by specifying a product group (e.g. a group of accessories for digital camera A, a group of replacement products for yogurt B, etc.), for example, in accordance with data organization in the unified catalogue. The unified catalogue may be further adjusted in accordance with the specification of the shopping basket (for example for shopping baskets specified per certain buyer's segment and/or certain products' attributes as, e.g. natural products, local origin products, etc.)

After the set of attributes is specified, the system starts calculating an association distance (312) between products sold in the shops of interest and the products specified in the shopping basket. The term “association distance” used in this patent specification includes a value characterizing a degree of association of a pair of products, typically associated with (and/or via) the same product. In accordance with certain embodiments of the present invention, the value may be presented as a mathematical function that converts differences in products' attributes into a numerical value. The smaller the association distance—the higher association degree between the products.

In a simplified non-limiting example illustrated in FIG. 4a for a pair of yogurts, any difference in the values of a specific attribute is marked as ‘1’ and identity is marked as ‘0’. The association distance, by way of non-limiting example, is calculated as a sum of differences in values corresponding to the specified set of parameters.

It will be understood that calculation of differences between the numeric values of attributes may be provided in different manners, for example, as arithmetical difference (equal to 1.5 between 1.5% fat and 3% fat; equal to 2 between 3% fat and 5% fat, etc.), as a weighed function, a non-symmetrical function (e.g. the difference is equal to 1 between 5% fat selected product and 3% fat associated product and equal to 2 between 3% fat selected product and 5% fat associated product), etc. The rules for calculating differences between attributes' values may differ for different products and/or different association criterion.

The numeric values for qualified attributes may be assigned in accordance with expert assessments or calculated in accordance with algorithms lnown in the art and evolutions thereof. The rules for converting the qualified values into quantified values may differ for different products or different association criterion or different buyers.

In certain embodiments of the invention, importance of attributes within the set may be different for different association criterion, different purposes of analyses, etc. Accordingly, the system assigns (311) a priority factor to one or more attributes in accordance with a set of rules obtained at stage (212). The priority factor may be assigned per a product group or per each product separately. In a simplified non-limiting example illustrated in FIG. 4b, the priority factor is implemented as a weight for difference of values of a specific attribute (3 for yogurt's type and 60 for environment). The priority factor may be implemented in other ways, e.g. as a weight for each difference grade within an attribute value (e.g. if specified that the priority factor is equal to number of grades within the difference of values, the priority factor for difference between 0% and 1.5% is equal to 1, between 0% and 3% is equal to 2, between 0% and 5% is equal to 3, between 0% and 9% is equal to 4, etc.). The above dependency of priority factor and number of grades may be nonlinear (e.g. the priority factor for difference between 0% and 1.5% is equal to 1, between 0% and 3% is equal to 4, between 0% and 5% is equal to 7, between 0% and 9% is equal to 11, etc.). By way of non-limiting example, if the shopping basket analysis is limited to a low-fat product, the priority factor for differences between 0%, 1.5% and 3% may be specified as zero, while anything from 5% fat and above gets a priority factor of 100, thus such products may not be replaced by alternatives.

Alternatively or additionally, the association distances may be also calculated off-line (or imported from a third party database) and stored in the product database.

If the calculated association distance fits a matching threshold (314), the products in the pair are regarded as associated. The matching threshold may depend on the product, association criterion, purposes of analyses and analyzing parameters, etc. The obtained matching threshold (313) may be predefined (e.g. per association criterion, per primary/generic product, etc.) or generated by the system in accordance with the obtained rules. The matching threshold may be assigned per a shopping basket and/or per each product (and/or group of products) separately and/or per buyer.

The association-related values of a product stored in the database (and/or in the unified catalogue and/or personal catalogue) may include at least one of the following:
association distances with one or more products calculated for one or more association criterion;
set of attributes for one or more association criterion for calculating an association distance;
set of rules for converting qualified values into quantified values
set of rules for calculating differences in values of attributes
priority factors for one or more association criterion for calculating the association distance;
matching threshold for one or more association criterion.

In certain embodiments of the invention the calculation of associated distance may be provided and estimated for subsets of the specified set of attributes. For example, if the set of attributes include weight or volume, the calculations of replaceable products may be provided in at least two steps:

1) specifying associated products without considering package attributes (e.g. weight, volume, type of packaging, etc.), and then

2) calculating association distance per weight/volume/package attributes among the products specified in the previous step and matching the result to allowable discrepancy (matching threshold). For example, 4×500 gr sugar bags are replaceable by 2×1 Kg sugar cans or by a 1×2 Kg can of the same sugar. If, for example, the product database contains the same sugar in packages of 500, 750 and 1100 grams, the matching threshold is 15% and the buyer has selected 2×500 grams, the package of 1100 grams will be considered as a replacing alternative, while the package of 750 grams—as non-replacing.

In certain embodiments of the invention, the generation of the list of associated products may be provided in accordance with a combination of the products specified in the basket. For example, if the specification comprises product A and product B, the list may be generated for a combination A+B (e.g. proposed replacement for separate shampoo and conditioner bottles may be a single bottle containing a shampoo+conditioner liquid).

In certain embodiments of the invention the generation of the list of associated products may be multi-level. For example, if the purpose of the shopping basket analyses is price comparison for an electronic device by manufacturers A and B, the first level of the list generation may comprise replacing alternatives of specified devices; the second level—accessories for each of said replacing alternatives, and the third level—bundled (e.g. promotional) products, etc.

Those skilled in the art will readily appreciate that the invention is not bound by the specific algorithm of association distance calculation, assigning the priority factor, matching and adjustment.

Referring back to FIG. 2, the list of associated products may be adjusted and/or optimized during or after generating. For example, optimization may be provided by calculating of association distance between associated products selling in different shops (or groups of shops) of interest and selecting for the optimized list of associated products only pairs matching certain criterion. The adjustment may be provided in accordance with different adjustment criterion. By way of non-limiting example, the adjustment may be provided in accordance with one or more of the following criteria:
specified preferences (e.g. black and white lists);
product availability at a certain period of time;
orientation of the analyses of shopping baskets to certain segment(s) of products/buyers;
delivery-related characteristics (products' expiration date, ability/inability to get delivery to the workplace, the need to coordinate a physical presence when delivery arrives, etc.);
package-related characteristics (e.g. if the list of associated products may comprise a package of 4×500 gr sugar bags (A), 2×1 Kg sugar cans (B) or by a 1×2 Kg sugar can (C); the list adjusted in accordance with adjustment criterion “no sugar in paper bags” will comprise products B and C, and the list adjusted in accordance with adjustment criterion “no sugar with weight exceeding lKg per item” will comprise products A and B).

Upon generating the list of associated products, the system (100) generates (215), in accordance with the obtained rules, shopping baskets for the shops of interest, and calculates (216) prices of the respective generated shopping baskets.

Non-limiting examples of a list of associated products generated in accordance with a specification in an initial shopping basket, as well as respective shopping baskets for the shops of interest, are illustrated in Tables 1-3.

TABLE 1
Specification of an initial shopping basket and products available in shops of interest

| Initial shopping | Initial shopping | Products available | Products available |
|---|---|---|---|
| basket. Variant A | basket. Variant B | in shop X | in shop Y |
| Apples - 1 Kg | Golden apples - 0.5 Kg; | Golden apples | Pink Lady |
| | Smith apples - 0.5 Kg | | Jonathan apples |
| Sugar - 2 Kg | 4 × 500 gr sugar bags; | 1 Kg sugar cans | 500 gr sugar bags, |
| | | 2 Kg sugar can | 1 Kg sugar cans; |
| Yogurt - 4*100 gr | Danona, plain, 3% fat - | Nestle, plain, 5% fat; | Nestle, plain, 1% fat |
| | 4*100 gr; | Danona, peach, 1% fat | Danona, peach, 5% fat |

TABLE 2
Lists of associated products generated per shops X and Y
for two variants of specification of the shopping basket

| List of associated | List of associated | |
|---|---|---|
| products (Variant A) | products (Variant B) | Notes |
| Golden apples | Golden apples | In Variant B association |
| Pink Lady | Jonathan apples | distance between Pink |
| Jonathan apples | | Lady and Golden/Smith |
| | | does not meet matching |
| | | threshold |
| 500 gr sugar bags; | 500 gr sugar bags; | Variant B is adjusted per |
| 1 Kg sugar cans; | 1 Kg sugar cans | requirement no package >1 Kg |
| 2 Kg sugar can | | |
| Nestle, plain, 5% fat; | Danona, peach, 1% fat; | In Variant B association |
| Danona, peach, 1% fat; | Nestle, plain, 1% fat | distance between 5% fat |
| Nestle, plain, 1% fat | | and 3% fat does not meet |
| Danona, peach, 5% fat | | matching threshold |

TABLE 3
Generated shopping baskets shops X and Y for variant A of specification of the initial shopping basket

| Initial shopping | List of associated | Shopping basket | Shopping basket | |
|---|---|---|---|---|
| basket. Variant A | products (Variant A) | for Shop X | for Shop Y | Selection criterion |
| Apples - 1 Kg | Golden apples | Golden apples - 1 Kg | Pink Lady - 1 Kg | The closest prices for |
| | Pink Lady | | | products of differ shops |
| | Jonathan apples | | | |
| Sugar - 2 Kg | 500 gr sugar bags; | 2 × 1 Kg sugar cans | 4 × 500 gr sugar bags | For each shop - the |
| | 1 Kg sugar cans | | | lowest price among |
| | 2 Kg sugar can | | | products of the shop |
| Yogurt - 4*100 gr | Nestle, plain, 5% fat; | Danona, peach, 1% fat | Danona, peach, 5% fat | Minimal association |
| | Danona, peach, 1% fat; | | | distance |
| | Nestle, plain, 1% fat | | | |
| | Danona, peach, 5% fat | | | |

The generation of the shopping baskets for the shops of interest includes matching the list of associated products to the products available in the respective shops in order to identify for each respective shop one or more products (referred to hereinafter as identified products) corresponding to certain products specified in the initial basket, and selecting among the identified products one or more products to be included in the shopping basket(s) generated for respective shop(s). The selection may be provided in accordance with different rules. For example, in certain embodiments of the invention the priority of selection may be as following: select among identified products of respective shop, a product fully matching the detailed specification of the product in the initial basket (if such detailed specification is available); if not available, select among the identified product(s) of the respective shop one or more products fully matching the identified product in another shop of interest; if not available, select in accordance with price selection criterion, etc. As illustrated, by way of non-limiting example, in Table 3, the selection criterion may be different for different products. In the illustrated example, the apples identified for Shop X are Golden apples and identified for Shop Y are Pink Lady apples and Jonathan apples; Pink Lady apples have been selected for the shopping basket of Shop Y as matching selection criterion “the closest price of products in different shops”. The sugar products identified for Shop X are 1 Kg sugar cans and 2 Kg sugar cans, and identified for Shop Y are 500 gr sugar bags and 1 Kg sugar cans; among them 1 Kg sugar cans have been selected for shopping basket of Shop X and 500 gr sugar bags have been selected for shopping basket of Shop Y as matching selection criterion “the lowest price among identified products of the shop”. Among the variety of identified yogurts, “Danona peach 1% fat” has been selected for the shopping basket of Shop X and “Danona peach 5% fat” has been selected for the shopping basket of Shop Y as matching the selection criterion of minimal association distance between the products of different shops. In certain embodiments of the invention the selection among identified products may result in multiple products wherein the requested quantity is distributed among these products in accordance with the obtained rules.

In certain embodiments of the invention the initial shopping basket may be specified in accordance with products of a certain shop among the shops of interest. The shopping basket generated for said certain shop need not necessarily be equal to said initial shopping basket, depending on availability of the products in the shop and/or selection rules/criterion.

In certain embodiments of the present invention the selection criterion may be related to quality and/or to price-quality relationship between the identified products. Such a criterion may be important, for example, for generating a shopping basket oriented to a segment of buyers who are ready to pay extra for more value (e.g. organic food, an ozone-safe product, etc.). The criterion may be based on a quality score as well as on another algorithm connecting the quality and price of selected product(s) with quality and price of associated products. For example, identified products A, B and C have respective prices P_{A}<P_{B}<P_{C}, and a quality related attribute with respective values α<β<γ. Each of the products may be provided with a quality score determined as a price of the product divided by respective value of the related attribute, and, for example, P_{A}/α<P_{B}/β while P_{A}/α>P_{C}/γ. Accordingly, the product C will be selected as having the best price/quality score.

It is possible that Shop X has no available product which may be associated with a product specified in the initial shopping basket, or products identified for a certain shop do not match a selection criterion. For such cases the system (100) may calculate the price of the shopping basket for Shop X as if the product selected for the shopping basket of Shop Y is also available in Shop X at the same price as calculated for Shop Y, or, alternatively, in accordance with prices of the associated products available in the system (e.g. best price, average price, etc.).

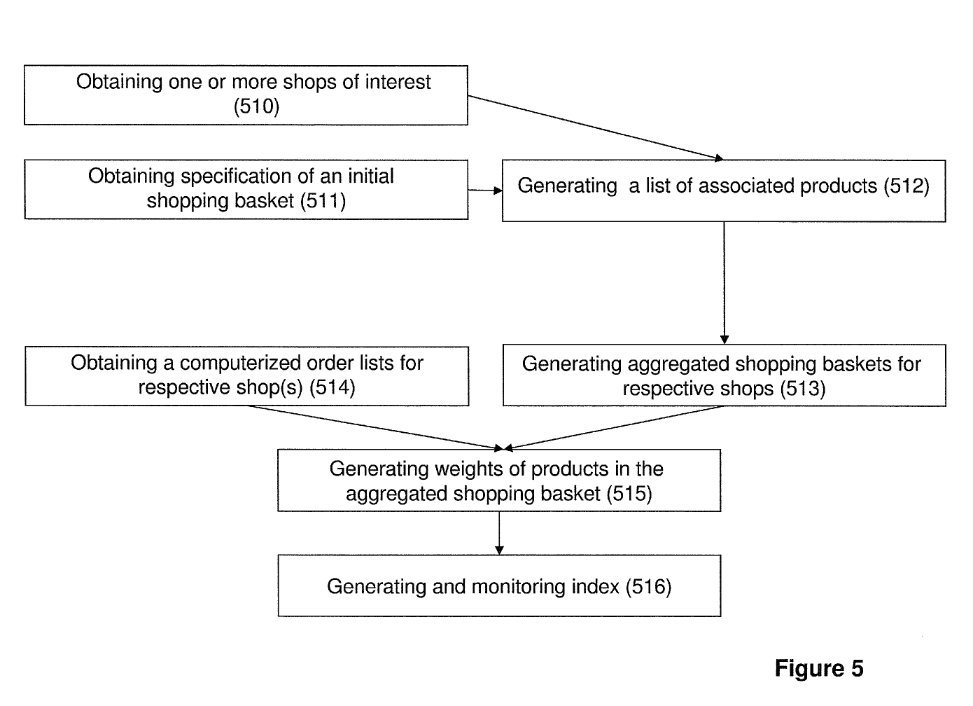

Upon calculating the prices of the generated shopping baskets, the system may, by way of non-limiting example, compare (217) the prices of shopping baskets for different shops and/or monitor (218) the price of basket(s) of one or more shops or a group of shops. The system may also generate and monitor static and dynamic indexes as will be further detailed with reference to FIG. 5. The results of price and/or index monitoring may be also used (219) (typically, together with results of shopping lists analyses) for dynamic specification of the initial shopping baskets (e.g. as 50 most popular super-market products during a certain period of time), correlation (220) of rules and/or adjusting the list of associated products (221). The results of analyses and/or derivatives thereof may be accommodated in the results database and/or sent to one or more external systems.

FIG. 5 illustrates, by way of non-limiting example, a generalized flow diagram showing the principal stages of operating the system for index generating and monitoring. Consumer (and alike) indexes are characterized by price data and weighting data. Price data for indexes are generally collected for a sample of goods and services from a sample of sales outlets in a sample of locations for a sample of times. In accordance with certain embodiments of the present invention, the initial shopping basket is specified (511) in accordance with said sample of goods and services, the shops of interest and availability period are specified (510) in accordance with said sample of sales outlets and the samples of time. Accordingly, in a manner similar to that detailed with reference to FIG. 2, the system (100) generates the list of associated products (512) and a shopping basket aggregating (513) the shopping baskets generated for the shops of interest (referred to hereinafter as aggregated shopping basket).

The weighting data for indexes are generally estimated as the shares of the different types of expenditure in the total expenditure covered by the index. In accordance with certain embodiments of the present invention, the system (100) obtains (514) computerized order lists from the shops of interest during the sampling period and calculates the respective shares of the products specified in aggregated shopping basket within said order lists, thus generating (515) respective weights of products in the aggregated shopping basket. The system further generates (516) the respective index by calculating the weighed price of the aggregated shopping basket. The weights of the products in the aggregated shopping basket may be dynamically amended in accordance with further obtained computerized order lists. Accordingly, the index may be monitored not only periodically, but also in a real time mode.

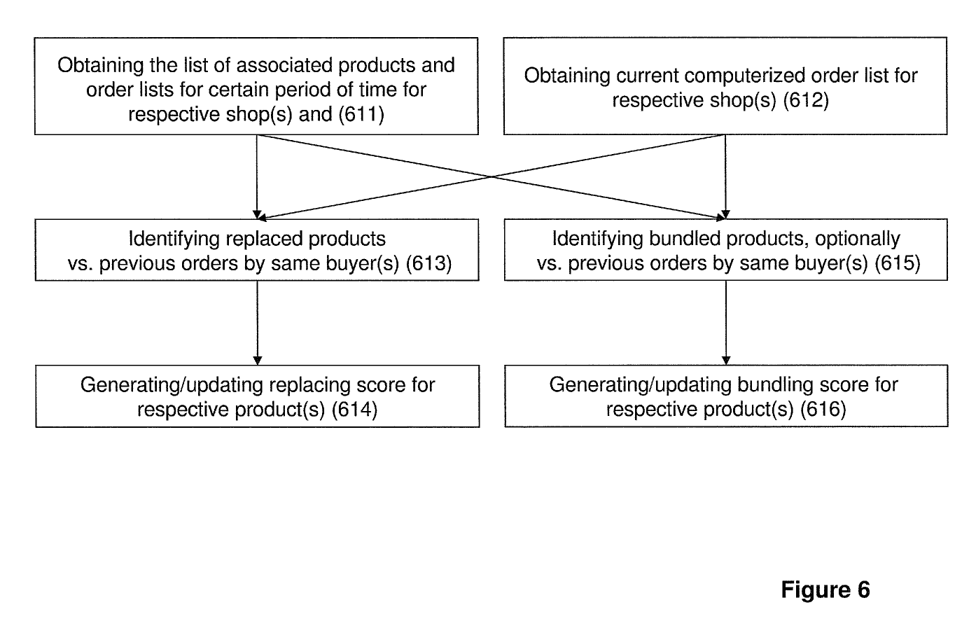

In a manner similar to the analysis of price parameters of the generated shopping baskets, the system may analyze, for example, effectiveness of promotion, bundling, customer loyalty to certain products/brands, etc. An exemplified generalized flow diagram of such analyses is illustrated in FIG. 6.

The system (100) obtains (611) the list of associated products (e.g. in a manner detailed with reference to FIGS. 2-4) corresponding to one or more shops of interest and one or more order lists corresponding to said shops and a certain period of time. The system also obtains (612) an order list corresponding to current ordering transaction with regard to at least one shop of interest (referred hereinafter as a “current order list”). The term “current order list” used in this patent specification should be expansively construed to cover any recent order list obtained by the system regardless of the time at which this order list has been generated. In preferred embodiments of the invention, the system obtains the current order list in real time or nearly real time with the ordering transactions. The system further identifies (613) products in the current order, replacing respective products in the previous orders by the same buyer(s). By way of non-limiting example, such identification may comprise the following steps:
identifying the buyer corresponding to the current order list;
identifying the previous order(s) by the same buyer (if available) arranged in accordance with an ordering date,
identifying for one or more products in the current order list at least one said previous order list comprising a product associated in the list of associated products to the product in the current order list as “replacing”.

The system (100) further calculates (614) a replacing score (or updates a previous score if available). Such a score may be used, by way of non-limiting example, as a measure of buyers' loyalty and/or quality of the respective products. The replacing score may be calculated in different ways. By way of non-limiting example, the ranking score may be calculated as an average number of repeating orders of a certain product before replacement. The algorithm of calculation of the replacing score may also take into consideration different factors generally used for market analyses, such as, for example, frequency of purchase of respective products, market segments, branding, promotional offers, etc. Alternatively or additionally, the system may compare the current order list with the last order list comprising the same or associated product and provide a positive score (e.g. “+1”) if the product in both orders is the same, and a negative score (e.g. “−1”) if the product has been replaced.

Optionally, prior to starting the above scoring process, the system (100) may identify for one or more certain products all previously accommodated order lists comprising said certain products and/or one or more product associated in the list of associated products to said certain products as “replacing”. The system may further calculate the initial replacing score of said certain products in a manner similar to that described above or otherwise. These initial replacing scores may be accommodated in the system (100) and further updated in accordance with an obtained current order.

By way of non-limiting example, the ranking of buyers' loyalty with regard to a certain product (and/or group of products) may be calculated as an average of replacing scores of all buyers (and/or certain groups) corresponding to order lists comprising the product. By alternative non-limiting example, the ranking may be calculated as a replacing score of a certain product for a buyers' group, wherein the orders of the buyers from said group are handled as if belonging to one body.

Those skilled in the art will readily appreciate that the invention is not bound by an algorithm of ranking calculation and/or specific implementation of replacing a score for measuring buyers' loyalty and/or quality of the respective products.

In a similar manner the system (100) may identify (615) for one or more products in the current order list at least one said previous order list comprising a product associated in the list of associated products to the product in the current order list as “bundled”, and to calculate (616) a respective bundling score.

Those skilled in the art will readily appreciate that the invention described for single buyers and shops is applicable, in a similar manner, to groups of buyers (e.g. grouped in accordance with a certain market segment, individual preferences, or otherwise) and/or groups of shops, manufacturers, distributors and/or combinations thereof.

The invention is not bound by the sequence of operations illustrated in FIGS. 2-6; equivalent functionality may be consolidated or divided in another manner. The invention is capable of other embodiments and of being practiced and carried out in various ways.

It will also be understood that the invention further contemplates a machine-readable memory tangibly embodying a program of instructions executable by the machine for executing the method of the invention.

Those skilled in the art will readily appreciate that various modifications and changes can be applied to the embodiments of the invention as hereinbefore described without departing from its scope, defined in and by the appended claims.

1. A method for computerized analyses of shopping basket parameters for at least a first shop of interest, the method comprising:
(a) obtaining a specification of an initial shopping basket;
(b) generating a list of associated products available in, at least, the first shop of interest;
(c) generating a first shopping basket corresponding to said first shop of interest.

2. The method of claim 1 further comprising:
(d) calculating a price of the generated first shopping basket.

3. The method of claim 2 further comprising:
(e) generating a second shopping basket corresponding to a second shop of interest;
(f) calculating a price of the generated second shopping basket,
(g) comparing the prices of the first and the second shopping baskets, wherein the list of associated products is generated in accordance with products available, at least, in the first and in the second shops of interest.

4. The method of claim 1 wherein generating the list of associated products comprises adjusting the list in accordance with at least one criterion selected from a group comprising specified preferences, product availability at a certain period of time, market segment, delivery-related characteristics, package-related characteristics.

5. The method of claim 1 wherein generating the shopping basket for the shop of interest includes matching the list of associated products to the products available in the shop in order to identify one or more products corresponding to a certain product specified in the initial basket, and selecting among the identified products one or more products to be included in the shopping basket generated for the shop.

6. The method of claim 3 wherein the specification of initial basket corresponds to the products of the second shop.

7. The method of claim 1 further comprising:
(d) obtaining a plurality of order lists corresponding to, at least, said first shop of interest,
(e) updating the specification of the initial shopping basket in accordance with analyses of, at least, said shopping lists and the generated first shopping basket.

8. The method of claim 1 further comprising:
(d) obtaining a plurality of previous order lists corresponding to, at least, said first shop of interest and arranged in accordance with dates of the orders,
(e) obtaining a current order list corresponding to, at least, said first shop of interest,
(f) identifying for one or more products in the current order list at least one said previous order list comprising a product associated in said list of associated products to the product in the current order list as “replacing”; and
(g) calculating a replacing score.

9. The method of claim 8 further comprising obtaining an initial replacing score of said one or more products, and updating the replacing score of said products in accordance with replacing score calculated in accordance with the obtained current order list.

10. The method of claim 8 wherein the calculated replacing score is used for estimation of a loyalty to the product of one or more buyers.

11. The method of claim 1 further comprising:
(d) obtaining a plurality of previous order lists corresponding to, at least, said first shop of interest and arranged in accordance with dates of the orders,
(e) obtaining a current order list corresponding to, at least, said first shop of interest,
(f) identifying for one or more products in the current order list at least one said previous order list comprising a product associated in said list of associated products to the product in the current order list as “bundled”; and
(g) calculating a bundling score.

12. A method for computerized analyses of shopping basket parameters for a plurality of shops of interest, the method comprising:
(a) obtaining a specification of an initial shopping basket;
(b) generating a list of associated products available in said plurality of shops of interest;
(c) obtaining a plurality of computerized order lists corresponding to said plurality of shops of interest and to a certain period of time;
(d) generating an aggregated shopping basket corresponding to said plurality of shops of interest;
(e) analyzing the obtained plurality of the computerized order lists together with the generated aggregated shopping basket, thereby calculating weights of the products comprised in the aggregated shopping basket;
(f) calculating a weighted price of the aggregated shopping basket.

13. The method of claim 12 further comprising updating the specification of the initial shopping basket in accordance with the calculated weights of products.

14. The method of claim 12 wherein the calculated weighted price is used for monitoring a consumer-related index.

15. A system for computerized analyses of shopping basket parameters for at least a first shop of interest, the system comprising:
(a) means for obtaining a specification of an initial shopping basket;
(b) means for generating a list of associated products available in, at least, the first shop of interest;
(c) means for generating a first shopping basket corresponding to said first shop of interest.

16. A system for computerized analyses of shopping basket parameters for a plurality of shops of interest, the system comprising:
(a) means for obtaining a specification of an initial shopping basket;
(b) means for generating a list of associated products available in said plurality of shops of interest;
(c) means for obtaining a plurality of computerized order lists corresponding to said plurality of shops of interest and to a certain period of time;
(d) means for generating an aggregated shopping basket corresponding to said plurality of shops of interest;
(e) means for analyzing the obtained plurality of the computerized order lists together with the generated aggregated shopping basket, thereby calculating weights of the products comprised in the aggregated shopping basket;
(f) means for calculating a weighted price of the aggregated shopping basket.

17. A program storage device readable by machine, tangibly embodying a program of instructions executable by the machine to perform method steps for computerized analyses of shopping basket parameters for at least a first shop of interest, the method comprising:
(a) obtaining a specification of an initial shopping basket;
(b) generating a list of associated products available in, at least, the first shop of interest;
(c) generating a first shopping basket corresponding to said first shop of interest.

18. A computer program product comprising a computer useable physical medium having computer readable program code embodied therein for computerized analyses of shopping basket parameters for at least a first shop of interest, the computer program product comprising:
(a) computer readable program code for causing the computer to obtain a specification of an initial shopping basket;
(b) computer readable program code for causing the computer to generate a list of associated products available in, at least, the first shop of interest;
(c) computer readable program code for causing the computer to generating a first shopping basket corresponding to said first shop of interest.
